(19) United States
(12) Patent Application Publication
(10) Pub. No.: US 2026/0248667 A1
(43) Pub. Date: Aug. 27, 2026

(54) SYSTEM AND APPARATUS FOR BEARING CATHETER CATCH BAG OR URINAL

(71) Applicant: Bernard Assistive Technologies, L.L.C., Palm Bay, FL (US)

(72) Inventors: Hal F. White, Palm Bay, FL (US); Sandra White, Rockledge, FL (US)

(21) Appl. No.: 19/544,203

(22) Filed: Feb. 19, 2026

Related U.S. Application Data
(60) Provisional application No. 63/761,274, filed on Feb. 21, 2025.

(51) Int. Cl. A61G 7/05; A61G 5/10; A61G 9/00

(52) U.S. Cl. CPC A61G 7/0503; A61G 5/1002; A61G 9/006

(57) ABSTRACT

An anchorable prop for use with mobility devices such as a wheelchair or walker, and resting devices such as beds, wherein the anchorable prop assists with upholding a catheter catch bag for users of a catheter, or upholding a urinal, into which urine can be drained. The anchorable prop can include a body, a loop, and a finger, wherein the loop and finger are configured to receive tubing and a hook from the catheter catch bag to uphold and secure the catheter catch bag, or alternatively and/or additionally include supports for fastening to a resting device such as a bed.

### CROSS REFERENCE TO RELATED APPLICATIONS

This application claims priority under 35 U.S.C. § 119(e) to provisional patent application U.S. Serial No. 63/761,274, filed February 21, 2025. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to an apparatus and/or system for supporting a catheter catch bag or urinal for a user confined to or otherwise using supportive equipment or physical assistance devices having applications in at least the assisted living or medical device industry. More particularly, but not exclusively, the present disclosure relates to a systems and apparatuses for bearing a catheter catch bag or urinal for mobility-impaired or resting users.

### BACKGROUND

Individuals requiring long-term catheterization typically rely on a catheter catch bag that accompanies them throughout daily activities to receive drainage from the catheter. Many of such users are confined to wheelchairs. Current methods for carrying around the catheter catch bag in conjunction with a wheelchair include hanging the catheter catch bag on a back of the wheelchair, thus making accessing the catheter catch bag very difficult for a user in the wheelchair. Further, this placement can elevate the catheter catch bag which can feed urine back into the person.

A second method is to include a larger bag secured underneath a seat of the user from axels of wheels on the wheelchair, in which the catheter catch bag is stuffed into the larger bag, a location that makes it very difficult to access—not only for users in the wheelchair but also for caregivers.

A third method is to position the catheter catch bag on an outside of the wheelchair against the wheels. This can cause problems with navigation as it gets in the way of the user moving the wheels, in addition to causing the bag to potentially acquire a wear-hole and leak.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to improve quality of life for those who are confined to wheelchairs and must stay connected to a catheter for extended periods of time. For example, such improvements to quality of life include, but are not limited to, providing ease of access to a catheter catch bag, increasing stability of securing the catheter catch bag during transport, reducing a likelihood of leakage of urine from tubing and/or the catheter catch bag, and reducing cumbersomeness of carrying around the catheter catch bag.

The apparatuses disclosed herein can be used in a wide variety of applications. For example, the apparatuses can be used on a variety of equipment and/or structures such as wheelchairs, walkers, bed frames, and the like for supporting and keeping elevated the catheter catch bag.

In one aspect, the present disclosure provides an anchorable prop that includes a body with a top side and a bottom, the body defining a cavity that is open at a first end of the body, and the cavity extending through a first side of the body to a second side of the body. The anchorable prop further includes a loop extending from a second end of the body defining a gap between the loop and the second end of the body. The anchorable prop further includes a finger protruding from the bottom of the body and extending in a direction towards the loop.

According to some additional aspects of the present disclosure, the anchorable prop further includes a ridged portion within the cavity.

According to some additional aspects of the present disclosure, the ridged portion comprises a substantially sinusoidal shape.

According to some additional aspects of the present disclosure, the finger comprises a continuous curve towards the loop.

According to some additional aspects of the present disclosure, the finger includes a bend and a straight portion.

According to some additional aspects of the present disclosure, the finger includes a widened portion at a distal end of the finger.

According to some additional aspects of the present disclosure, the anchorable prop further includes apertures extending through the body from the bottom to the top side.

According to some additional aspects of the present disclosure, the apertures each comprise a different diameter on the bottom than a diameter of the apertures on the top side.

According to some additional aspects of the present disclosure, the anchorable prop further includes a bulk portion extending from the bottom in which the finger extends from the bulk portion.

According to some additional aspects of the present disclosure, the anchorable prop further includes an indent on the top side, wherein the indent is circular in shape, between five millimeters to thirty millimeters in depth, and including a diameter of 30 millimeters to 60 millimeters.

According to some additional aspects of the present disclosure, the anchorable prop is 3D printed and comprises one of a PETG material, a TPEG material, an ABS material, a PLA material, an ASA material, a Nylon material, or a carbon fiber material.

According to some other aspects of the present disclosure, a system for urine drainage that includes the anchorable prop and a wheelchair, wherein the anchorable prop attaches to the wheelchair via inserting a wheelchair seat of the wheelchair into the cavity.

According to some additional aspects of the present disclosure, a ridged portion within the cavity grips the wheelchair seat.

According to some additional aspects of the present disclosure, the system further includes apertures on the body of the anchorable prop, wherein screws are inserted through the apertures and into the wheelchair.

According to some additional aspects of the present disclosure, the system further includes a catheter catch bag, and a hook extending from a top of the catheter catch bag, wherein the hook is configured to be positioned within the loop of the anchorable prop.

According to some additional aspects of the present disclosure, the system further includes tubing extending from the catheter catch bag to connect with a catheter.

According to some additional aspects of the present disclosure, a portion of the tubing is placed on the finger, the hook extends through the loop, and the hook biases the tubing in a direction away towards the body of the anchorable prop.

According to some other aspects of the present disclosure, a method for upholding a catheter catch bag on a wheelchair, in which the method includes attaching the anchorable prop to a wheelchair, placing tubing which is connected to a catheter catch bag above the finger and beneath the loop of the anchorable prop, and inserting a hook which is connected to the catheter catch bag into the loop such that the hook biases the tubing towards the wheelchair.

According to some additional aspects of the present disclosure, the anchorable prop is positioned at a center point of a front of a wheelchair seat.

According to some other aspects of the present disclosure, an anchorable prop for fastening to a bed frame, wherein the anchorable prop includes a body, a loop extending away from the body defining a gap, a narrow extension extending from the body on a side opposite the loop, a first support extending from a bottom of the body in between the loop and the narrow extension substantially orthogonal from the body, a second support extending from the narrow extension substantially orthogonal from the narrow extension, and a ribbed portion on the second support configured to improve grip against a flat-faced object, wherein the first support and the second support are spaced apart from one another, and the first support includes an aperture extending therethrough, and the body is thicker than the narrow extension.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and are not necessarily to scale unless otherwise indicated.

FIG. 1 shows a perspective view of a system for urine drainage on a wheelchair between an individual’s legs according to various aspects of the present disclosure.

FIG. 2 shows a perspective view of an anchorable prop according to various aspects of the present disclosure.

FIG. 3 shows a right elevation view of the anchorable prop of FIG. 2 according to various aspects of the present disclosure.

FIG. 4 shows a second perspective view of the anchorable prop of FIG. 2 according to various aspects of the present disclosure.

FIG. 5 shows a third perspective view of the anchorable prop of FIG. 2 according to various aspects of the present disclosure.

FIG. 6 shows a perspective view of an additional anchorable prop according to various aspects of the present disclosure.

FIG. 7 shows a side elevation view of the anchorable prop of FIG. 6.

FIG. 8 shows a perspective view of yet another anchorable prop according to various aspects of the present disclosure.

FIG. 9 shows a side elevation view of the anchorable prop of FIG. 8 according to various aspects of the present disclosure.

FIG. 10 shows a top plan view of the anchorable prop of FIG. 8 according to various aspects of the present disclosure.

FIG. 11 shows a perspective view of yet an additional anchorable prop according to various aspects of the present disclosure.

FIG. 12 shows a second perspective view of the anchorable prop of FIG. 11 according to various aspects of the present disclosure.

FIG. 13 shows a third perspective view of the anchorable prop of FIG. 11 according to various aspects of the present disclosure.

FIG. 14 shows a perspective view of an anchorable prop without a finger according to various aspects of the present disclosure.

FIG. 15 shows a bottom perspective view of a system for urine drainage according to various aspects of the present disclosure.

FIG. 16 shows an enlarged perspective view of the system of FIG. 15 according to various aspects of the present disclosure.

FIG. 17 shows an anchorable prop attached to a walker according to various aspects of the present disclosure.

FIG. 18 shows a first perspective view of an additional system for urine drainage according to various aspects of the present disclosure.

FIG. 19 shows a bottom perspective view of the system of FIG. 18 according to various aspects of the present disclosure.

FIG. 20 shows an additional perspective view of the system of FIG. 18 according to various aspects of the present disclosure.

FIG. 21 shows yet another perspective view of the system of FIG. 18 according to various aspects of the present disclosure.

FIG. 22 shows a perspective view of a female urinal being used in place of a male urinal that is used in the system of FIG. 18 according to various aspects of the present disclosure.

FIG. 23 shows a first perspective view of an additional anchorable prop for use with the system of FIG. 18 according to various aspects of the present disclosure.

FIG. 24 shows a second perspective view of the anchorable prop of FIG. 23 according to various aspects of the present disclosure.

FIG. 25 shows a perspective view of a screw to be used in conjunction with the anchorable prop of FIG. 23 according to various aspects of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated. Various embodiments are provided herein labeled as the anchorable prop (e.g., 110, 210, 310, 410) simply to illustrate variations of the present disclosure and is not intended to be limiting as separate embodiments that are exclusive, but instead serve as various examples of how the anchorable prop can be modified to and varied without departing from the spirit and scope of the present disclosure. Note further that “anchorable prop” described herein refers to the respective device as being both anchorable (to a wheelchair, a bed, a walker, etc.) and capable of propping up another object (with either or both of a hook or finger or otherwise being capable of keeping another object lifted off the ground, the main object of emphasis being a catheter catch bag and associated tubing).

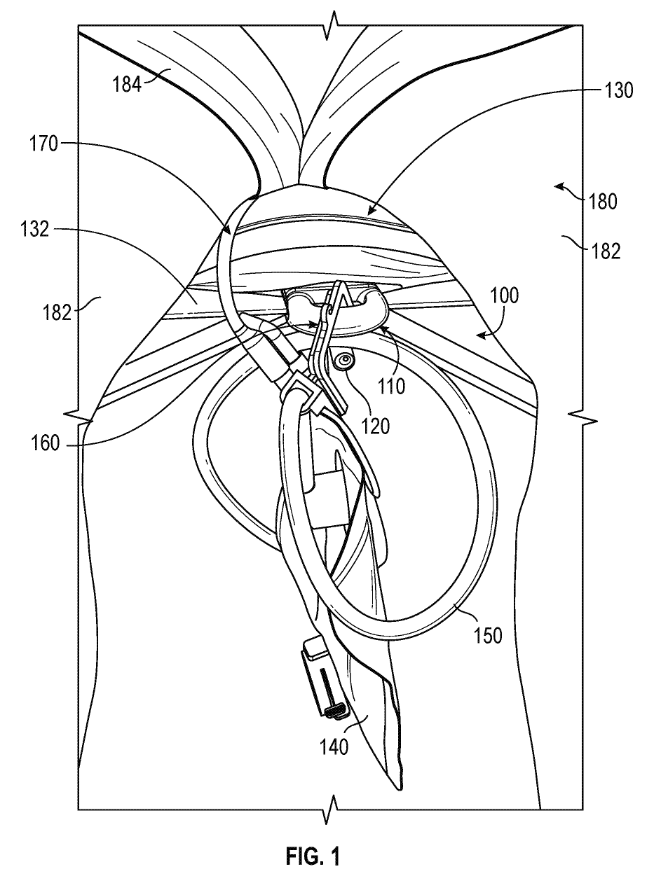

FIG. 1 shows a perspective view of a urine drainage system 100 including an anchorable prop 110 attached to a seat 132 of a wheelchair 130, and further including a catheter catch bag 140 with tubing 150 attached to the anchorable prop 110 via a hook 160. The urine drainage system 100 further includes a catheter 170 inserted into a user 180 and attached to the tubing 150 for emptying fluids from the user 180 into the catheter catch bag 140. FIG. 1 further shows legs 182 of the user 180 and shorts or clothing 184 of the user 180 for context of where the anchorable prop 110 is positioned on the wheelchair 130.

The urine drainage system 100 utilizes the anchorable prop 110 in conjunction with the wheelchair 130 to uphold the catheter catch bag 140 for users of the wheelchair 130 that rely on carrying the catheter catch bag 140 with them for extended periods of time. The anchorable prop 110 attaches to the wheelchair 130, and the catheter catch bag 140 is upheld by the anchorable prop 110 by the tubing 150 and the hook 160. As will be described herein, the tubing 150 and the hook 160 are upheld by the anchorable prop 110 so as to secure the catheter catch bag 140. The urine drainage system 100 receives urine from a user via the catheter 170 which directs urine to the tubing 150 and into the catheter catch bag 140.

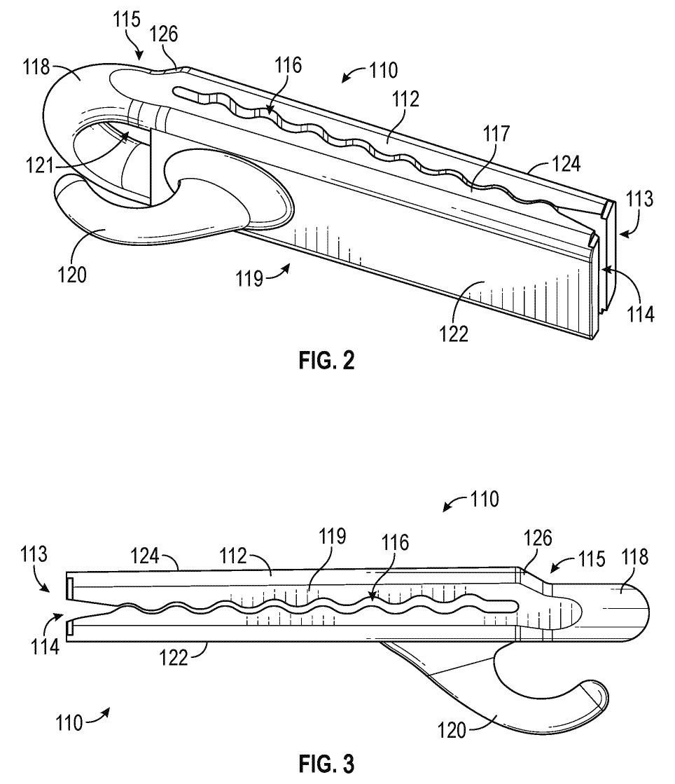

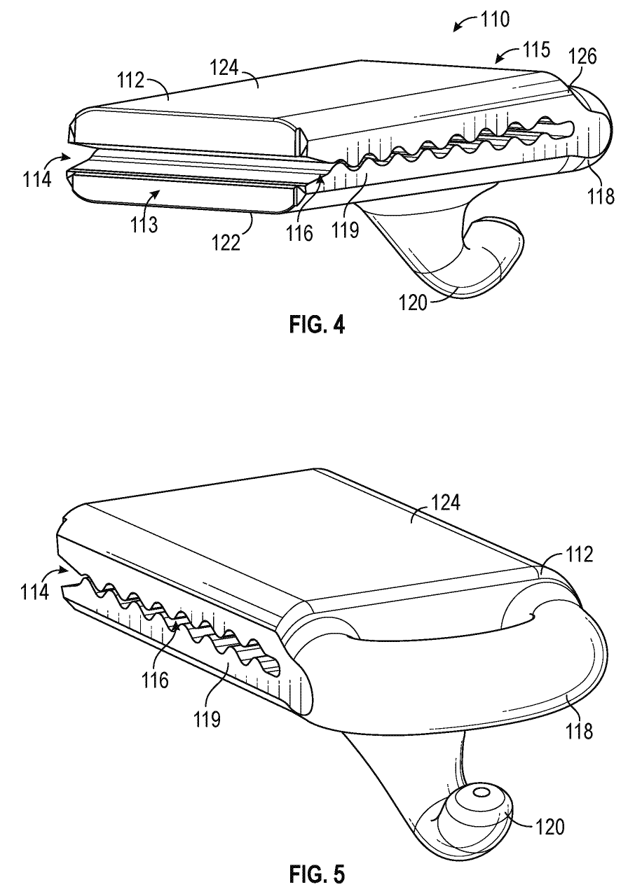

FIGS. 2–5 show varying views of the anchorable prop 110. The anchorable prop 110 includes a body 112 with a first end 113 and a cavity 114 extending through the first end 113. The anchorable prop 110 further includes a second end 115 positioned opposite the first end 113 with a loop 118 thereat, and passageway or gap 121 positioned between the second end 115 and the loop 118. Further, inside the cavity 114 the anchorable prop 110 can include a ridged portion 116 that define undulating or jagged variations of an interior of the cavity 114 from the first end 113 towards the second end 115, wherein the ridged portion 116 extends from a first side 117 to a second side 119. Additionally, the anchorable prop 110 includes a finger 120 positioned on a bottom 122 of the anchorable prop 110, with a top side 124 positioned opposite the bottom 122, wherein the anchorable prop 110 can further include a bolstering portion 126 at a transition between the second end 115 and the loop 118.

The body 112 of the anchorable prop 110 defines a cavity 114, which is open at a first end 113 of the body 112 and closed at a second end 115. The cavity 114 can extend completely through a first side 117 of the body 112 to a second side 119 of the body 112. At the first end 113 of the body 112 in which the cavity 114 is open, the cavity 114 can diverge to a widest distance in height such as to form an open mouth for receiving objects inserted into the cavity.

The cavity 114 includes the ridged portion 116 extending into the body 112 from the first end 113 much like teeth. As shown, the ridged portion 116 includes hills and valleys on both a bottom interior and a top interior of the cavity 114. The ridged portion 116 can vary a distance of open space between the bottom interior in the top interior of the cavity 114 within the body 112 along a length of the body from the first end 113 to the second end 115 or include a consistent cavity 114 height while transitioning from hill to valley along the ridged portion 116. Alternatively, the ridged portion 116 can widen a gap of the cavity 114 while simultaneously varying a height of the cavity 114. As such, the ridged portion 116 can create a sinusoidal wave shape when viewing the cavity 114 from a side elevation perspective. The ridged portion 116 can further include modifications to the sinusoidal wave shape such as increasing or decreasing in amplitude along a length of the cavity 114 within the body 112. From the first side 117 opening of the cavity 114 to the second side 119 opening of the cavity 114 the cavity 114 can include a constant height or a varying height.

The body 112 can further include the loop 118 extending from the second end 115 of the body 112. The loop 118 can extend from a same side of the body 112 as a side of the body 112 in which the cavity 114 is closed. The loop 118 can substantially be a same thickness as the body 112 from top 124 to bottom 122 or a reduced thickness. The loop 118 can comprise a U-shape with an open end of the “U” attached to the body 112 at the second end 115. Further, an exterior surface of the loop 118 can simultaneously be flush with the first side 117 of the body 112 and the second side 119 of the body 112. Furthermore, the loop 118 can define the gap 121 between an interior of the loop 118 and the body 112. Moreover, the loop 118 need not be a perfect U-shape and can comprise a V-shape, a C-shape, a half-square shape, etc., so long as the loop 118 forms the gap 121 between the body 112 and the loop 118. It is to be further understood that the loop 118 can comprise a hook shape in which only one distal end of the U-shape attaches to the body 112 such that the loop 118 comprises more of a J-shape.

Extending from the bottom 122 of the body 112 is the finger 120. The finger 120 can generally extend a first direction substantially orthogonal to the bottom 122 of the body 112 and then can change direction to extend a direction substantially parallel to a direction to which the body 112 extends. The finger 120 can further change direction so as to extend in a direction towards the body 112 so as to form a hook shape. The finger 120 can include joints or be a continuous curve to accomplish these directional changes. The finger 120 can originate as a protuberance positioned on the bottom 122 between the first side 117 and the second side 119 of the body 112. The protuberance of the finger 120 can decrease in width with increasing distance from the body 112. The finger 120 can alternatively be a consistent width throughout an entirety of the finger 120. There can further include a plurality of fingers 120 such as one, two, three, or more fingers 120. The plurality of fingers 120 can further vary in distance extended from the body 112 or in distance extended along the distance in which the loop 118 extends, and can extend from any of the bottom 122, the first side 117, the second side 119, or the second end 115. Furthermore, the finger 120 can even extend from the loop 118 and back toward the body 112 in a direction opposite of that shown in FIGS. 2–5, or even perpendicular to the direction shown in FIGS. 2–5.

The body 112 can further include the bolstering portion 126 on the top side 124 when the loop 118 is not as thick as the body 112. The bolstering portion 126 can comprise a gradual reduction in thickness of the body 112 rather than an immediate reduction in thickness. The bolstering portion 126 can make longer a height, width, or distance of the body 112 so as to strengthen a durability of the body 112 surrounding a portion of the body 112 in which the cavity 114 concludes. The bolstering portion 126 can further contribute to a greater sturdiness in a transition from the body 112 to the loop 118 or allow for decreased weight in the anchorable prop 110 by retaining strength in the body 112 and reducing an amount of material in the loop 118. Further still, the bolstering portion 126 can be positioned at the second end 115 on the bottom 122 rather than the top 124.

Each of edges and surfaces surrounding the body 112, the loop 118, and the finger 120 can be chamfered, rounded, or ergonomically shaped so as to provide comfort for a user when handling or physically interacting with the anchorable prop 110. Further, edges and surfaces of the body 112, the loop 118, and the finger 120 can be substantially flat or squared-off to be flush with or in minimal disruption with neighboring surfaces of objects in which the anchorable prop 110 can contact.

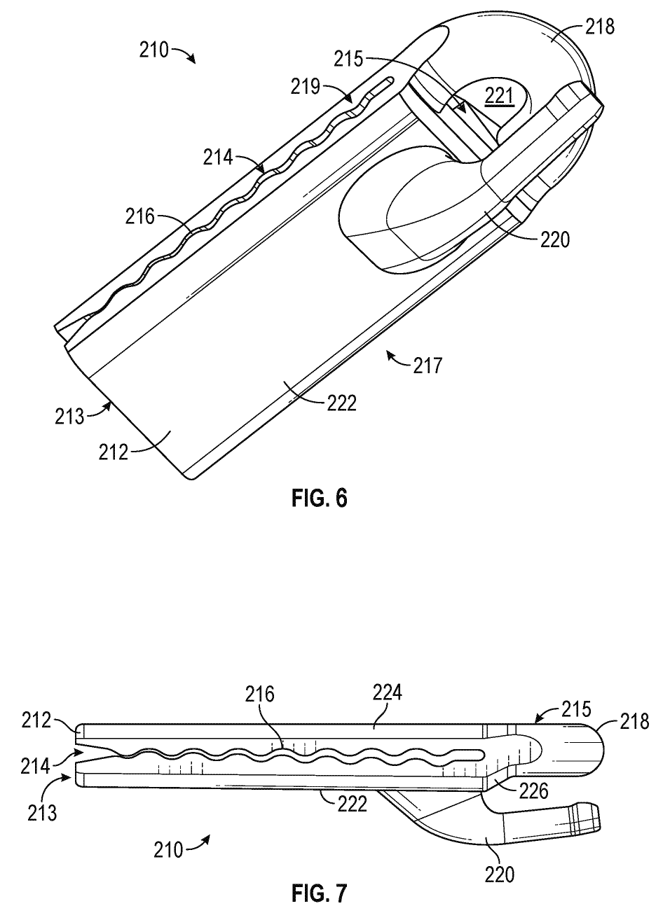

FIGS. 6–7 show an alternative anchorable prop 210. The anchorable prop 210 includes a body 212 with a first end 213 and a cavity 214 extending through the first end 213. The anchorable prop 210 further includes a second end 215 positioned opposite the first end 213 with a loop 218 thereat, and a gap 221 positioned between the second end 215 and the loop 218. Further, inside the cavity 214 the anchorable prop 210 can include a ridged portion 216 that define undulating or jagged variations of an interior of the cavity 214 from the first end 213 towards the second end 215, wherein the ridged portion 216 extends from a first side 217 to a second side 219. Additionally, the anchorable prop 210 includes a finger 220 positioned on a bottom 222 of the anchorable prop 210, with a top side 224 positioned opposite the bottom 222, wherein the anchorable prop 210 can further include a bolstering portion 226 at a transition between the second end 215 and the loop 218.

As can be seen in the figures, the anchorable prop 210 differs from the anchorable prop 110 in that the finger 220 has an altered shape, in which the finger 120 curvingly extends outward from the bottom 122 for an entirely of the finger 120, whereas the finger 220 curvingly extends outward from the bottom 222 and then includes a straight portion such that the straight portion is longer than a curved portion of the finger 220. This differs from the finger 120 of FIGS. 2–5 in that the finger 120 includes a substantially continuous curvature to appear more hook-shaped rather than peg-shaped like a wall coat-hanger for the finger 220. Furthermore, the finger 220 includes generally a bulbed portion at a distal end of the finger 220 in which the finger 220 thickens, the purpose of which will be described herein.

Moreover, the anchorable prop 210 further differs from the anchorable prop 120 of FIGS. 2–5 in that the bolstering portion 226 extends from the bottom 222 of the body 212 rather than the top side 224 of the body. In this regard, the loop 218 provides a greater distance from an interior of the finger 220 thus allowing the finger 220 to remain closer to the body 212 (for tighter tolerances, in which the finger 120 extends further away from the body 112) for increased stability and strength creating less of a moment on the body 212 when a weight is placed on the finger 220 which is nearer the body 212 than the finger 120 is to the body 112. This is not to say that placing the bolstering portion 226 on the bottom 222 of the anchorable prop 210 is always superior as placing the bolstering portion 226 on the top side 224 also has advantages such as providing a lip for a hook to further secure itself against which hook will be described herein. Further still, it is to be understood that the bolstering portion 226 could in its entirety be done away with in which a height of the loop 218 is flush with a height of the body 212 from the top side 224 to the bottom 222, or alternatively still, the anchorable props 110, 210 can comprise the bolstering portion 126, 226 on each of the top 124, 224 and the bottom 122, 222 for an even thinner loop 118, 218.

The body 212 of the anchorable prop 210 defines a cavity 214, which is open at a first end 213 of the body 212 and closed at a second end 215. The cavity 214 can extend completely through a first side 217 of the body 212 to a second side 219 of the body 212. At the first end 213 of the body 212 in which the cavity 214 is open, the cavity 214 can be at a widest distance in height such as an open mouth for inserting onto objects.

The cavity 214 includes the ridged portion 216 extending into the body 212 from the first end 213 much like teeth. As shown, the ridged portion 216 includes hills and valleys on both a bottom interior and a top interior of the cavity 214. The ridged portion 216 can vary a distance of open space between the bottom interior in the top interior of the cavity 214 within the body 212 along a length of the body from the first end 213 to the second end 215 or include a consistent cavity 214 height while transitioning from hill to valley along the ridged portion 216. Alternatively, the ridged portion 216 can widen a gap of the cavity 214 while simultaneously varying a height of the cavity 214. As such, the ridged portion 216 can create a sinusoidal wave shape when viewing the cavity 214 from a side elevation perspective. The ridged portion 216 can further include modifications to the sinusoidal wave shape such as increasing or decreasing in amplitude along a length of the cavity 214 within the body 212. From the first side 217 opening of the cavity 214 to the second side 219 opening of the cavity 214 the cavity 214 can include a constant height or a varying height.

The body 212 can further include the loop 218 extending from the second end 215 of the body 212. The loop 218 can extend from a same side of the body 212 as a side of the body 212 in which the cavity 214 is closed. The loop 218 can substantially be a same thickness as the body 212 from top 224 to bottom 222 or a reduced thickness. The loop 218 can comprise a U-shape with an open end of the “U” attached to the body 212 at the second end 215. Further, an exterior surface of the loop 218 can simultaneously be flush with the first side 217 of the body 212 and the second side 219 of the body 212. Furthermore, the loop 218 can define the gap 221 between an interior of the loop 218 and the body 212. Moreover, the loop 218 need not be a perfect U-shape and can comprise a V-shape, a C-shape, a half-square shape, etc., so long as the loop 218 forms the gap 221 between the body 212 and the loop 218. It is to be further understood that the loop 218 can comprise a hook shape in which only one distal end of the U-shape attaches to the body 212 such that the loop 218 comprises more of a J-shape.

Extending from the bottom 222 of the body 212 is the finger 220. The finger 220 can generally extend a first direction substantially orthogonal to the bottom 222 of the body 212, and then can change direction to extend a direction substantially parallel to a direction in which the body 212 extends. The finger 220 can further change direction so as to extend in a direction towards the body 212 so as to form a hook shape. The finger 220 can include joints or be a continuous curve to accomplish these directional changes. The finger 220 can originate as a protuberance positioned on the bottom 122 between the first side 117 and the second side 219 of the body 212. The protuberance of the finger 220 can decrease in width with increasing distance from the body 212. The finger 220 can alternatively be a consistent width throughout an entirety of the finger 220. There can further include a plurality of fingers 220 such as one, two, three, or more fingers 220. The plurality of fingers 220 can further vary in distance extended from the body 212 or in distance extended along the distance in which the loop 218 extends and can extend from any of the bottom 222, the first side 217, the second side 219, or the second end 215. Furthermore, the finger 220 can even extend from the loop 218 and back toward the body 212 in a direction opposite of that shown in FIGS. 6–7, or even perpendicular to the direction shown in FIGS. 6–7.

Each of edges and surfaces surrounding the body 212, the loop 218, and the finger 220 can be chamfered, rounded, or ergonomically shaped so as to provide comfort for a user when handling or physically contacting the anchorable prop 210. Further, edges and surfaces of the body 212, the loop 218, and the finger 220 can be substantially flat or squared-off to be flush with or in minimal disruption which neighboring surfaces of objects in with the anchorable prop 210 can contact.

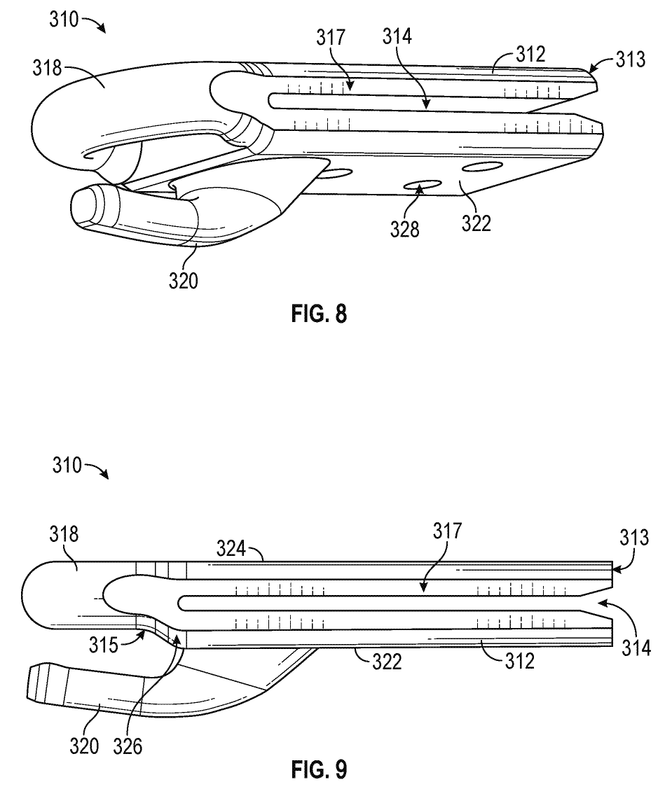

FIGS. 8–10 show an alternative example of anchorable prop 310. The anchorable prop 310 includes a body 312 with a first end 313 and a cavity 314 extending through the first end 313. The anchorable prop 310 further includes a second end 315 positioned opposite the first end 313 with a loop 318 thereat, and a gap 321 positioned between the second end 315 and the loop 318. Further, the anchorable prop 310 includes a finger 320 positioned on a bottom 322 of the anchorable prop 310, with a top side 324 positioned opposite the bottom 322, wherein the anchorable prop 310 can further include a bolstering portion 326 at a transition between the second end 315 and the loop 318. Additionally, the anchorable prop 310 can include apertures 328 extending through each of the top side 324 and the bottom 322.

As can be seen in the figures, the anchorable prop 310 differs from the anchorable prop 210 in that the anchorable prop 310 includes the apertures 328 and does not include a ridged portion. The apertures 328 can include a single aperture 328, two, three, four, five, or more apertures 328. The apertures 328 as will be described herein allow for a different form of anchoring than the anchorable prop 110 or the anchorable prop 210, in which the substantially smooth cavity 314 assists with ease of installation by sliding smoothly onto the wheelchair seat 132 and attaching via utilizing the apertures 328 with any of screws, rivets, nails, threaded rods, bolts, pins, anchors, etc. inserted through the apertures 328 and the wheelchair seat 132. However, it is understood that the anchorable prop 110 and the anchorable prop 210 can also include the apertures 328, or further that the anchorable prop 310 include the ridges 116, 216 within the cavity 314. Inclusion of both the ridges and the apertures in a single embodiment would simply lead to increased attaching reinforcement while making installation slightly more intensive. Moreover, the apertures 328 can comprise a constant width throughout or a varying width throughout so as to be capable of receiving and accommodating different fastening mechanisms.

The body 312 of the anchorable prop 310 defines a cavity 314, which is open at a first end 313 of the body 312 and closed at a second end 315. The cavity 314 can extend completely through a first side 317 of the body 312 to a second side 319 of the body 312. At the first end 313 of the body 312 in which the cavity 314 is open, the cavity 314 can be at a widest distance in height such as an open mouth for inserting onto objects.

The body 312 can further include the loop 318 extending from the second end 315 of the body 312. The loop 318 can extend from a same side of the body 312 as a side of the body 312 in which the cavity 314 is closed. The loop 318 can substantially be a same thickness as the body 312 from top 324 to bottom 322 or a reduced thickness. The loop 318 can comprise a U-shape with an open end of the “U” attached to the body 312 at the second end 315. Further, an exterior surface of the loop 318 can simultaneously be flush with the first side 317 of the body 312 and the second side 319 of the body 312. Furthermore, the loop 318 can define the gap 321 between an interior of the loop 318 and the body 312. Moreover, the loop 318 need not be a perfect U-shape and can comprise a V-shape, a C-shape, a half-square shape, etc., so long as the loop 318 forms the gap 321 between the body 312 and the loop 318. It is to be further understood that the loop 318 can comprise a hook shape in which only one distal end of the U-shape attaches to the body 312 such that the loop 318 comprises more of a J-shape.

Extending from the bottom 322 of the body 312 is the finger 320. The finger 320 can generally extend a first direction substantially orthogonal to the bottom 322 of the body 312 and then can change direction to extend a direction substantially parallel to a direction to which the body 312 extends. The finger 320 can further change direction so as to extend in a direction towards the body 312 so as to form a hook shape. The finger 320 can include joints or be a continuous curve to accomplish these directional changes. The finger 320 can originate as a protuberance positioned on the bottom 322 between the first side 317 and the second side 319 of the body 312. The protuberance of the finger 320 can decrease in width with increasing distance from the body 312. The finger 320 can alternatively be a consistent width throughout an entirety of the finger 320. There can further include a plurality of fingers 320 such as one, two, three, or more fingers 320. The plurality of fingers 320 can further vary in distance extended from the body 312 or in distance extended along the distance in which the loop 318 extends, and can extend from any of the bottom 322, the first side 317, the second side 319, or the second end 315. Furthermore, the finger 320 can even extend from the loop 318 and back toward the body 312 in a direction opposite of that shown in FIGS. 8–10, or even perpendicular to the direction shown in FIGS. 8–10.

The body 312 can further include the bolstering portion 326 on the top side 324 when the loop 318 is not as thick as the body 312. The bolstering portion 326 can comprise a gradual reduction in thickness of the body 312 rather than an immediate reduction in thickness. The bolstering portion 326 can make longer a height, width, or distance of the body 312 so as to strengthen a durability of the body 312 surrounding a portion of the body 312 in which the cavity 314 concludes. The bolstering portion 326 can further contribute to a greater sturdiness in a transition from the body 312 to the loop 318 or allow for decreased weight in the anchorable prop 310 by retaining strength in the body 312 and reducing an amount of material in the loop 318. Further still, the bolstering portion 326 can be positioned at the second end 315 on the bottom 322 rather than the top 324. Further still, it is to be understood that the bolstering portion 326 could in its entirety be done away with in which a height of the loop 318 is flush with a height of the body 312 from the top side 324 to the bottom 322, or alternatively still, the anchorable prop 310 can comprise the bolstering portion 326 on each of the top 324 and the bottom 322 for an even thinner loop 318.

Each of edges and surfaces surrounding the body 312, the loop 318, and the finger 320 can be chamfered, rounded, or ergonomically shaped so as to provide comfort for a user when handling or physically interacting with the anchorable prop 310. Further, edges and surfaces of the body 312, the loop 318, and the finger 320 can be substantially flat or squared-off to be flush with or in minimal disruption with neighboring surfaces of objects in which the anchorable prop 310 can contact.

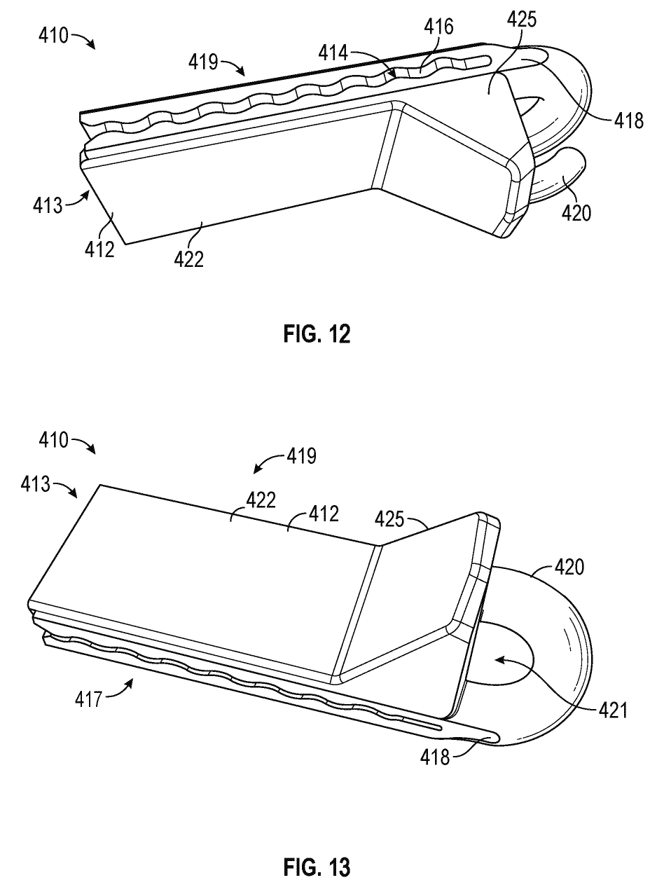

FIGS. 11–13 show varying views of yest another example of the anchorable prop 410 according to various aspects of the present disclosure. The anchorable prop 410 includes a body 412 with a first end 413 and a cavity 414 extending through the first end 413. The anchorable prop 410 further includes a second end 415 positioned opposite the first end 413 with a loop 418 thereat, and a gap 421 positioned between the second end 415 and the loop 418. Further, inside the cavity 414 the anchorable prop 410 can include a ridged portion 416 that define undulating or jagged variations of an interior of the cavity 414 from the first end 413 towards the second end 415, wherein the ridged portion 416 extends from a first side 417 to a second side 419. Additionally, the anchorable prop 410 includes a finger 420 extending outwardly from a bulk extension 425 of the anchorable prop 410. The anchorable prop 410 further includes a top side 424 positioned opposite the bottom 422, wherein the anchorable prop 410 can further include a bolstering portion 426 at a transition between the second end 415 and the loop 418.

As can be seen in the figures, the anchorable prop 410 differs from previously described anchorable props in that the anchorable prop 410 includes the bulk extension 425. As shown, the bulk extension 425 can comprise substantially a triangular cross-sectional shape. The bulk extension 425 can extend substantially orthogonal to the body 425. Furthermore, the finger 420 can extend directly from the bulk extension 425 rather than from the body 412. A primary purpose of this embodiment is to provide greater stability when hanging weight from the finger 420 by reducing a length of the finger 420 as compared to the fingers 120, 220, 320 and placing the strain on the bulk extension 425. It is to be understood that the bulk extension 425 can be any suitable shape extending downwardly from the bottom 422 to increase thickness of the anchorable prop 410 at an origination of the finger 420 and need not comprise a substantially triangular cross-sectional shape including but not limited to a trapezoidal cross-sectional shape, a rectangular cross-sectional shape, a square cross-sectional shape, a semicircular cross-sectional shape, a circular cross-sectional shape, an arcuate cross-sectional shape, a polygonal cross-sectional shape, an oval cross-sectional shape and so forth.

The body 412 of the anchorable prop 410 defines a cavity 414, which is open at a first end 413 of the body 412 and closed at a second end 415. The cavity 414 can extend completely through a first side 417 of the body 412 to a second side 419 of the body 412. At the first end 413 of the body 412 in which the cavity 414 is open, the cavity 414 can be at a widest distance in height such as an open mouth for inserting onto objects.

The cavity 414 includes the ridged portion 416 extending into the body 412 from the first end 413 much like teeth. As shown, the ridged portion 416 includes hills and valleys on both a bottom interior and a top interior of the cavity 414. The ridged portion 416 can vary a distance of open space between the bottom interior in the top interior of the cavity 414 within the body 412 along a length of the body from the first end 413 to the second end 415 or include a consistent cavity 414 height while transitioning from hill to valley along the ridged portion 416. Alternatively, the ridged portion 416 can widen a gap of the cavity 414 while simultaneously varying a height of the cavity 414. As such, the ridged portion 416 can create a sinusoidal wave shape when viewing the cavity 414 from a side elevation perspective. The ridged portion 416 can further include modifications to the sinusoidal wave shape such as increasing or decreasing in amplitude along a length of the cavity 414 within the body 412. From the first side 417 opening of the cavity 414 to the second side 419 opening of the cavity 414 the cavity 414 can include a constant height or a varying height.

The body 412 can further include the loop 418 extending from the second end 415 of the body 412. The loop 418 can extend from a same side of the body 412 as a side of the body 412 in which the cavity 414 is closed. The loop 418 can substantially be a same thickness as the body 412 from top 424 to bottom 422 or a reduced thickness. The loop 418 can comprise a U-shape with an open end of the “U” attached to the body 412 at the second end 415. Further, an exterior surface of the loop 418 can simultaneously be flush with the first side 417 of the body 412 and the second side 419 of the body 412. Furthermore, the loop 418 can define the gap 421 between an interior of the loop 418 and the body 412. Moreover, the loop 418 need not be a perfect U-shape and can comprise a V-shape, a C-shape, a half-square shape, etc., so long as the loop 418 forms the gap 421 between the body 412 and the loop 418. It is to be further understood that the loop 418 can comprise a hook shape in which only one distal end of the U-shape attaches to the body 412 such that the loop 418 comprises more of a J-shape.

The finger 420 can extend in substantially a same direction as the loop 418 away from the bulk extension 425. The finger 420 can include joints or be a continuous curve to accomplish directional changes. The finger 420 can originate as a protuberance positioned on the bulk extension 425 between the first side 417 and the second side 419 of the body 412. The protuberance of the finger 420 can decrease in width with increasing distance from the bulk extension 425. The finger 420 can alternatively be a consistent width throughout an entirety of the finger 420. There can further include a plurality of fingers 420 such as one, two, three, or more fingers 420. The plurality of fingers 420 can further vary in distance extended from the bulk extension 425 or in distance extended along the distance in which the loop 418 extends, and can extend from any of the bottom 422, the first side 417, the second side 419, or the second end 415. Furthermore, the finger 420 can even extend from the loop 418 and back toward the body 412 in a direction opposite of that shown in FIGS. 11–13, or even perpendicular to the direction shown in FIGS. 11–13

Each of edges and surfaces surrounding the body 412, the loop 418, and the finger 420 can be chamfered, rounded, or ergonomically shaped so as to provide comfort for a user when handling or physically interacting with the anchorable prop 410. Further, edges and surfaces of the body 412, the loop 418, and the finger 420 can be substantially flat or squared-off to be flush with or in minimal disruption with neighboring surfaces of objects in which the anchorable prop 410 can contact.

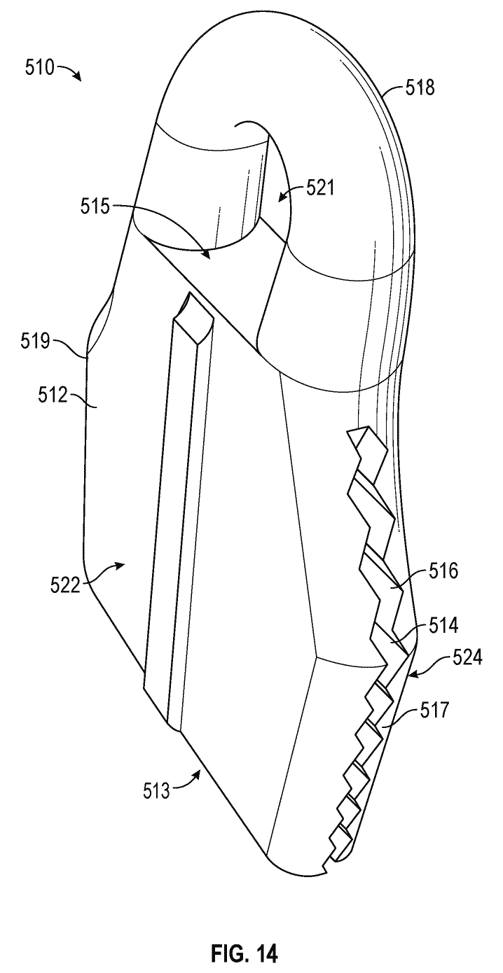

FIG. 14 shows yet another anchorable prop 510. The anchorable prop 510 includes a body 512 with a first end 513 and a cavity 514 extending through the first end 513. The anchorable prop 510 further includes a second end 515 positioned opposite the first end 513 with a loop 518 thereat, and a gap 521 positioned between the second end 515 and the loop 518. Further, inside the cavity 514 the anchorable prop 510 can include a ridged portion 516 that define undulating or jagged variations of an interior of the cavity 514 from the first end 513 towards the second end 515, wherein the ridged portion 516 extend from a first side 517 to a second side 519.

As opposed to previous embodiments of the anchorable prop, the anchorable prop 510 does not include a finger. As such, the anchorable prop 510 has a minimalistic design from which a catheter catch bag can hang (from the loop 518). Further as shown, the anchorable prop 510 can include ridged portion 516 that are more angular in shape and less curvaceous. Furthermore, the anchorable prop 510 includes a widening portion of the body 512 so as to encompass a greater surface area to which the anchorable prop 510 attaches.

The body 512 of the anchorable prop 510 defines a cavity 514, which is open at a first end 513 of the body 512 and closed at a second end 515. The cavity 514 can extend completely through a first side 517 of the body 512 to a second side 519 of the body 512. At the first end 513 of the body 512 in which the cavity 514 is open, the cavity 514 can be at a widest distance in height such as an open mouth for inserting onto objects.

The cavity 514 includes the ridged portion 516 extending into the body 512 from the first end 513 much like teeth. As shown, the ridged portion 516 includes hills and valleys on both a bottom interior and a top interior of the cavity 514. The ridged portion 516 can vary a distance of open space between the bottom interior in the top interior of the cavity 514 within the body 512 along a length of the body from the first end 513 to the second end 515 or include a consistent cavity 514 height while transitioning from hill to valley along the ridged portion 516. Alternatively, the ridged portion 516 can widen a gap of the cavity 514 while simultaneously varying a height of the cavity 514. As such, the ridged portion 516 can create a sinusoidal wave shape when viewing the cavity 514 from a side elevation perspective. The ridged portion 516 can further include modifications to the sinusoidal wave shape such as increasing or decreasing in amplitude along a length of the cavity 514 within the body 512.

The body 512 can further include the loop 518 extending from the second end 515 of the body 512. The loop 518 can extend from a same side of the body 512 as a side of the body 512 in which the cavity 514 is closed. The loop 518 can substantially be a same thickness as the body 512 from top 524 to bottom 522 or a reduced thickness. The loop 518 can comprise a U-shape with an open end of the “U” attached to the body 512 at the second end 515. Further, an exterior surface of the loop 518 can simultaneously be flush with the first side 517 of the body 512 and the second side 519 of the body 512. Furthermore, the loop 518 can define the gap 521 between an interior of the loop 518 and the body 512. Moreover, the loop 518 need not be a perfect U-shape and can comprise a V-shape, a C-shape, a half-square shape, etc., so long as the loop 518 forms the gap 521 between the body 512 and the loop 518. It is to be further understood that the loop 518 can comprise a hook shape in which only one distal end of the U-shape attaches to the body 512 such that the loop 518 comprises more of a J-shape.

Each of edges and surfaces surrounding the body 512, the loop 518, and the finger 520 can be chamfered, rounded, or ergonomically shaped so as to provide comfort for a user when handling or physically interacting with the anchorable prop 510. Further, edges and surfaces of the body 512, the loop 518, and the finger 520 can be substantially flat or squared-off to be flush with or in minimal disruption with neighboring surfaces of objects in which the anchorable prop 510 can contact.

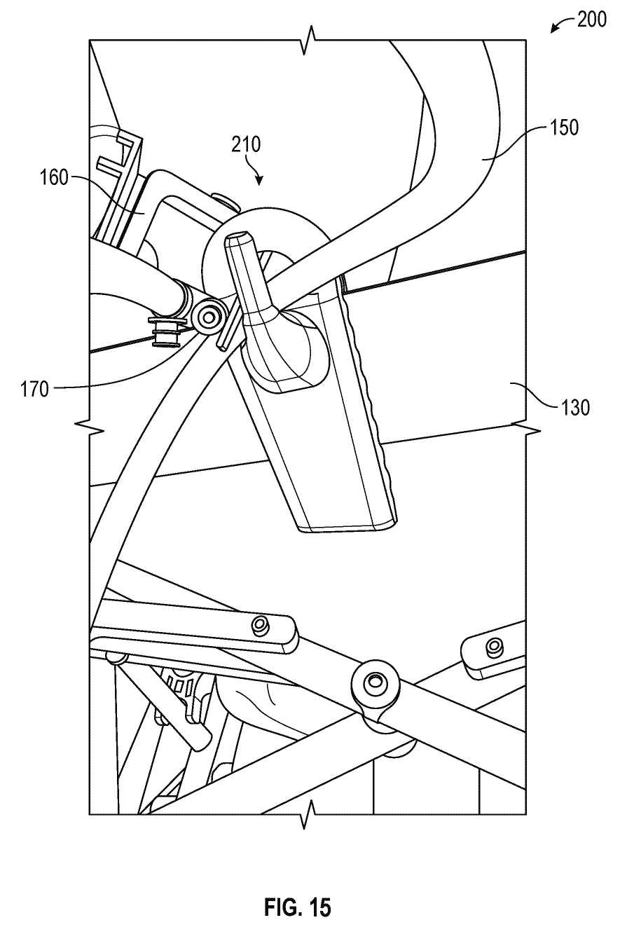

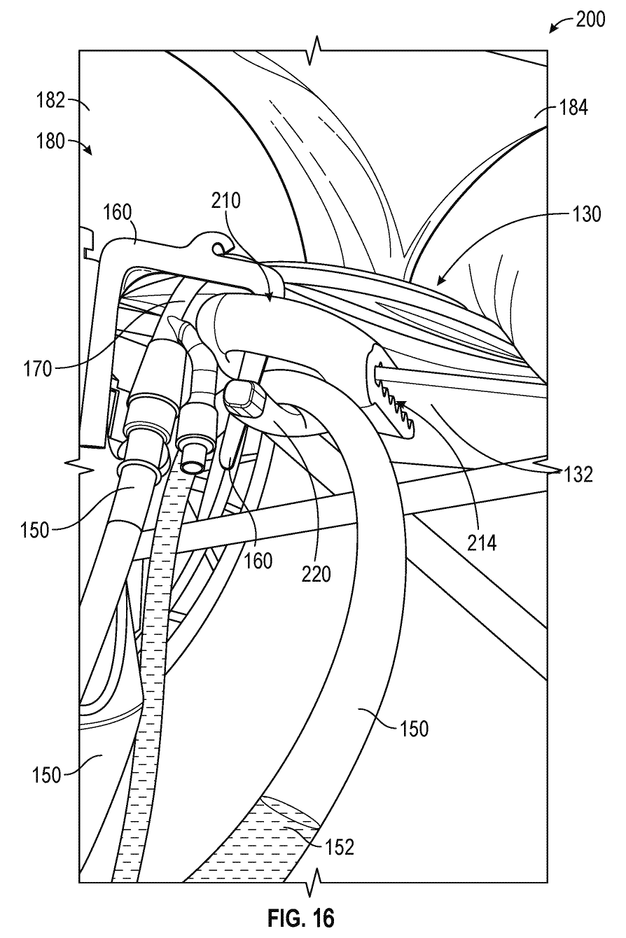

FIGS. 15–16 show varying views of the anchorable prop 210 attached to the wheelchair 130 in the system 200. While FIGS. 15–16 show the same wheelchair 130 are related components as shown and discussed in FIG. 1, FIGS. 15–16 serve at least one purpose of showing a different anchorable prop (namely the anchorable prop 210) attached to the wheelchair 130. FIG. 15–16 show the system 200 and the anchorable prop 210, the wheelchair 130 with the wheelchair seat 132, and it is understood that the catheter catch bag 140 is attached to the tubing 150 and hangs from the hook 160 with catches liquid coming from the a catheter 170 even though the catheter catch bag 140 is only partially shown in FIG. 15. Additionally, FIG. 16 shows the user 180 with legs 182 and clothing 184 for context. FIG. 16 further shows urine 152 or a liquid within the tubing 150.

The urine drainage system 200 utilizes the anchorable prop 210 in conjunction with the wheelchair 130 to uphold the catheter catch bag 140 for users of the wheelchair 130 that rely on carrying the catheter catch bag 140 with them for extended periods of time. The anchorable prop 210 attaches to the wheelchair 130 via inserting the wheelchair seat 132 in the cavity 214, and the catheter catch bag 140 is upheld by the anchorable prop 110 by the tubing 150 and the hook 160. As will be described herein, the tubing 150 and the hook 160 are upheld by the anchorable prop 210 so as to secure the catheter catch bag 140. The urine drainage system 200 receives urine from the user 180 via the catheter 170 which directs urine 152 to the tubing 150 and into the catheter catch bag 240.

As shown in FIGS. 15–16, the tubing 150 can wrap around the finger 220. Furthermore, the hook 160 can extend through the loop 218 downwardly so as to secure the tubing 150 at an interior of the finger 220 in which the hook 160 biases the tubing 150 towards the second end 215 of the body 212 and prevent the tubing 150 from sliding off the finger 220. As explained herein, the finger 220 can include a widened portion or a bulged portion at the distal end of the finger 220 in which this also aids in preventing the tubing 150 from sliding off the finger 220. It is to be understood that the widened portion can be included on any anchorable prop that includes a finger. It is also to be understood that a more curvaceous finger can further contribute to cradling the tubing 150 and preventing the tubing 250 from sliding off the finger.

This design of having the fingers 120, 220, 320, 420 below the loop 118, 218, 318, 418 is advantageous in that it is incredibly easy for a user of the wheelchair to remove or insert the hook 160 directly in between legs of the user 180 and into the loop 118, 218, 318, 418 and gain access to the catheter catch bag 140 without requiring assistance of another person to reach behind the wheelchair, underneath a seat of the wheelchair, or crane over a side of the wheelchair. Contrast this with users who experience general difficulty in wheelchairs with accessing the catheter catch bag 140 when positioned within a larger bag underneath the wheelchair due to needing to bend so far forward to extend arms down into the larger bag underneath the wheelchair and being at awkward positions to remove the catheter catch bag or simply requiring assistance from another individual who must squat or get on bended knee to reach underneath the wheelchair or even require placing their head very near an opening of the larger bag underneath the wheelchair just to properly see how to grab and remove the catheter catch bag without complication. In such situations the catheter catch bag being positioned in the larger bag is arduous even for able-bodied people. Furthermore, users of the larger bag positioned under the wheelchair seat rather than using any of the anchorable props 110, 210, 310, 410, 510 can experience inconveniences such as pinched tubing blocking flow, leakage of the catheter catch bag into the larger bag when turned, twisted, or rotated in unintended directions or otherwise put askew with relation to tubing connecting to the catheter catch bag.

Furthermore, it is advantageous for embodiments of the present disclosure to design a distance between an exterior of the loop 218 to an interior of a distal end of the finger 220 to be slightly larger than a diameter of the tubing 150 so as to adequately receive, hold, and secure the tubing 150. Furthermore, securing the tubing 150 as shown removes the tubing 150 from reach of feet of the user 180 or even ground on which the wheelchair 130 stands upon so as to prevent the catheter 170 from being pulled from the user in the wheelchair 130.

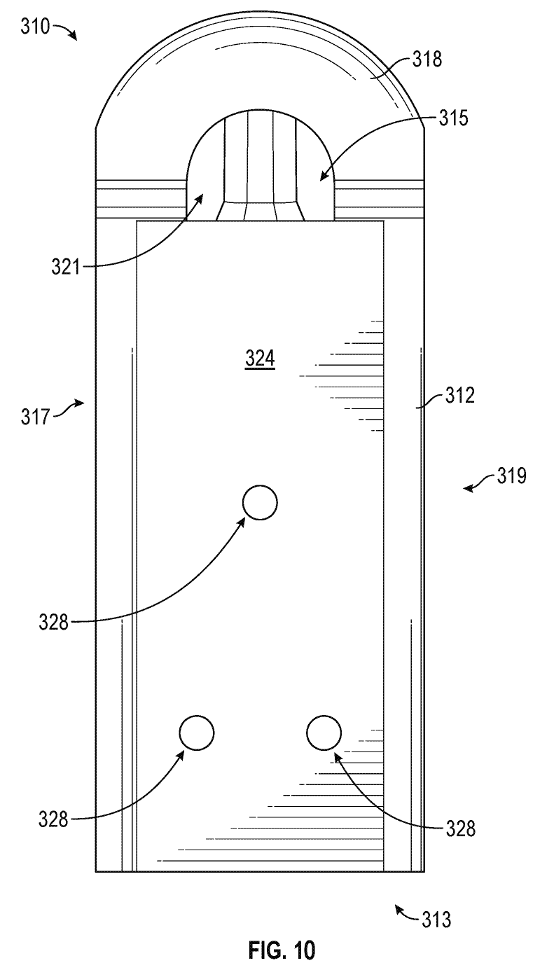

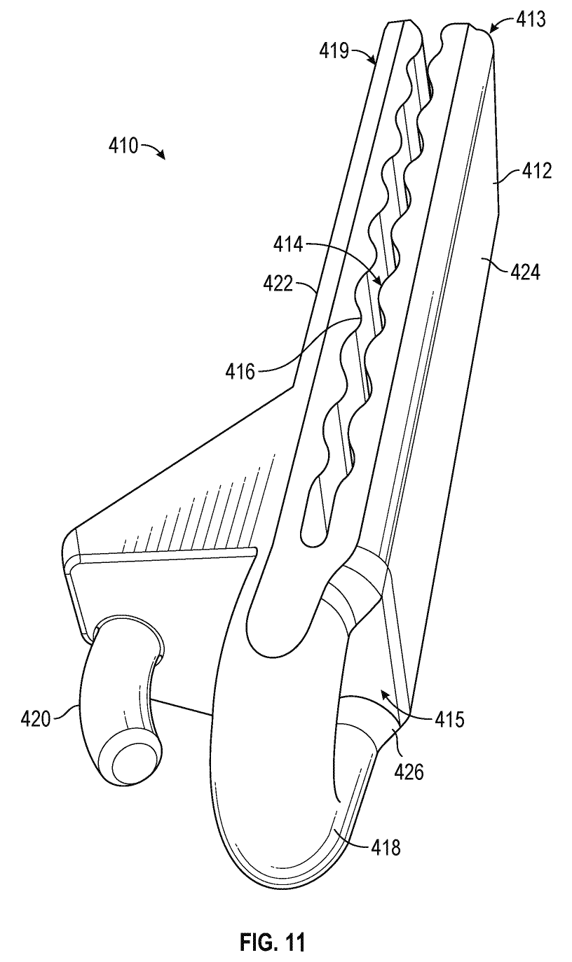

As shown in FIGS. 15–16, only the loop 218 and the finger 220 are visible as portions that are extending away from or in front of the wheelchair seat 132. This is because the body 212 of the anchorable prop 210 is clamped onto the seat 132 of the wheelchair 130, and more particularly at a mid or center point of a seat of the wheelchair seat 132 such that the anchorable prop 210 is positioned in a place that is out of way from portions of the seat from which legs of the user most regularly extend. The ridged portion 216 engages the seat of the wheelchair 130 so as to prevent unintended removal of the anchorable prop 210 from the wheelchair 130. It is to be understood that the anchorable prop 210 can include apertures such as those shown in FIGS. 8 and 10 so as to more securely fasten the anchorable prop 210 to the wheelchair 230 via screws, threaded rods, bolts, and nuts, nails, rivets, etc.

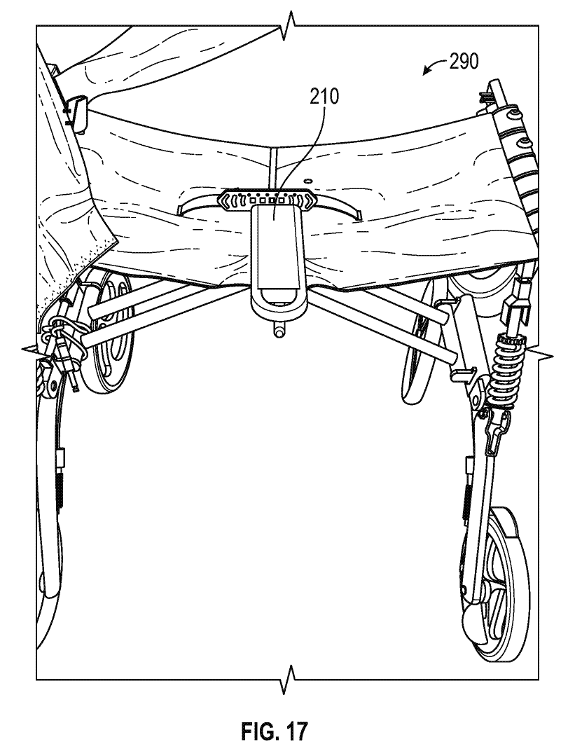

It is to be understood that the anchorable prop 210 is not the sole anchorable prop 110, 210, 310, 410, 510 that can be used with the wheelchair 230 nor the anchorable prop 110 being the sole anchorable prop 110, 210, 310, 410, 510 that can be used with the wheelchair 130 as any of the anchorable props 110, 210, 310, 410, 510 can be used with the wheelchairs 130, 230 and have the advantages described herein with relation to the anchorable props 110, 210 shown (with the exception of the anchorable prop 510 as it relates to advantages with having the finger 120, 220, 320, 420). The same is likewise true for the walker 290 shown in FIG. 17.

FIG. 17 shows the anchorable prop 210 in use with a walker 290, in which all connections and securing of a catheter catch bag described herein in conjunction with a wheelchair can be applied thus providing ease of access to the catheter catch bag to those not entirely confined to a wheelchair but can additionally have access to mobility via the walker.

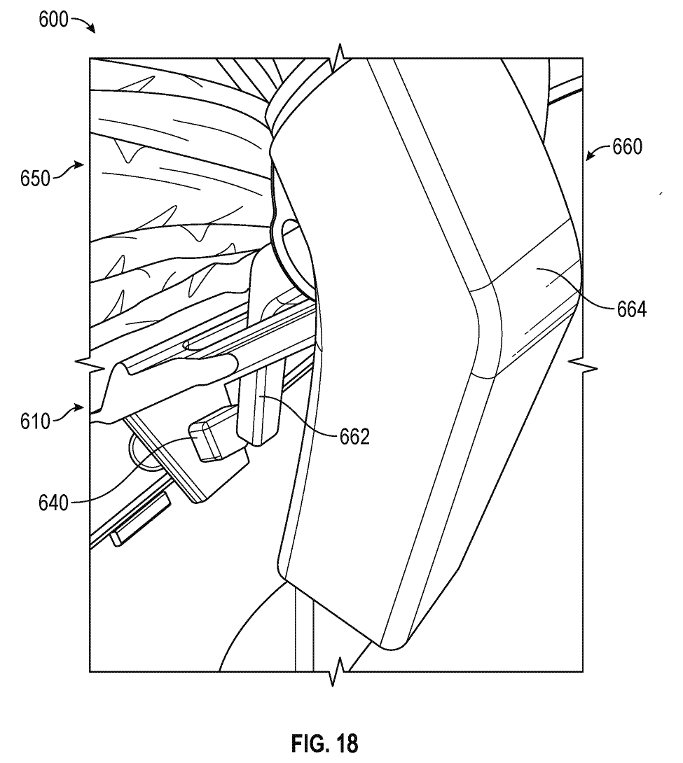

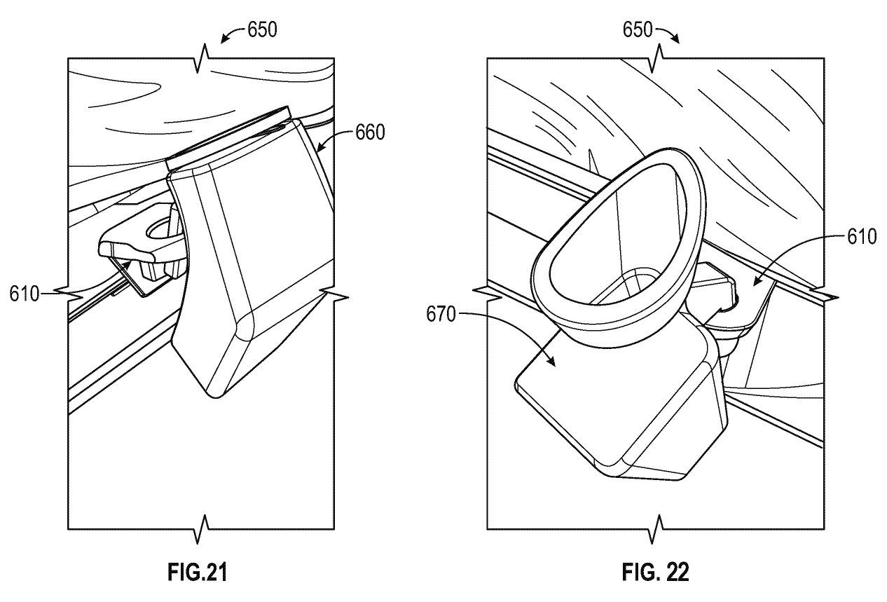

FIGS. 18–22 show a system 600 according to various aspects of the present disclosure. The system 600 can include an anchorable prop 610, a screw 640, a bed 650, and either of a male urinal 660, or a female urinal 670 (see FIG. 22).

As shown in FIGS. 18–22, anchorable prop 610 is attached to the bed 650. The bed 650 can include a bed frame 652, and a mattress 654. The anchorable prop 610 attaches to the bed frame 652 as will be described herein. After the anchorable prop 610 is secured to the bed 650, the urinal 660, 670 can be inserted into the anchorable prop 610 for use at a side of the bed 650.

The system 600 is simple in both assembly and function. Namely, a user lifts the mattress 654, places the anchorable prop 610 on the bed frame 652, lets the mattress 654 rest back on top of both the anchorable prop 610 and the bed frame 652, inserts the screw 640 into the anchorable prop 610, and then inserts the urinal 660, 670 into the anchorable prop 610 via placing a handle 662 of the urinal 660 into the anchorable prop 610.

The system 600 is then ready for use. Namely, a user sleeping in the bed 650 can wake up, position themselves above a container 664 of the urinal 660, 670 and then urinate into the urinal 660, 670, for disposal thereof in the morning. In some instances, users of the system 600 can have a difficult time using the restroom (not just in getting up and walking to the restroom such as those confined to wheelchairs, but also being able to urinate at all), in which case the urinal 660, 670 can act as a very near container to which a user in bed 650 attached to a catheter can insert a distal end of the catheter tube into the urinal 660, 670. Alternatively, a catheter catch bag can be hung from the anchorable prop 610 like that shown in the systems 100, 200 shown in FIGS. 1 and 15–16.

The system 600 has many advantages. First and foremost being that users who are generally confined to a bed can rest comfortably while having easy access to a place to urinate without requiring assistance from others. The system 600 is easily installable to a bed frame and does not require any tools or excess strength to be able to install. Lifting a side of a mattress 654 is the greatest amount of strength needed so as to place the anchorable prop 610 on the bed frame 652 (no more difficult than applying sheets to a bed). The installer can then via hand insert the screw 640 into the anchorable prop 610 to secure the anchorable prop 610 around the bed frame 652 thus improving stability of the system 600. Between a second support (described below) and the screw 640 being pressed up against the bed frame 652 and with the mattress 654 on top thereof, the system 600 is capable of not only holding the urinal 660, 670 up off the ground, but is also fully capable of supporting a urine-full urinal 660, 670 without dropping or having the anchorable prop 610 break in any way. This ease of installation and use thereof is further magnified by the fact that the urinal 660, 670 can easily be lifted up and removed from the anchorable prop 610 by a user simply by lifting the handle 662 of the urinal 660 out of the anchorable prop 610.

Furthermore, the screw 640 need not be exactly a screw. It can be additionally be devices other than a screw to fasten the anchorable prop 610 to the bed 650 including but not limited to a bolt and nut, a threaded rod, rivet, dowel pins, cotter pins, split pins, a clip, a snap-fitted structure, adhesive-based alternatives featuring glue, tape, or hook-and-loop fasteners, magnetic fasteners, clamps, anchors such as a toggle bolt, an expansion anchor, or a wedge anchor, magnets, etc. Additionally, the urinal 660, 670 can include a cap or cover for sealing the device and keeping both odors and liquids contained during resting time.

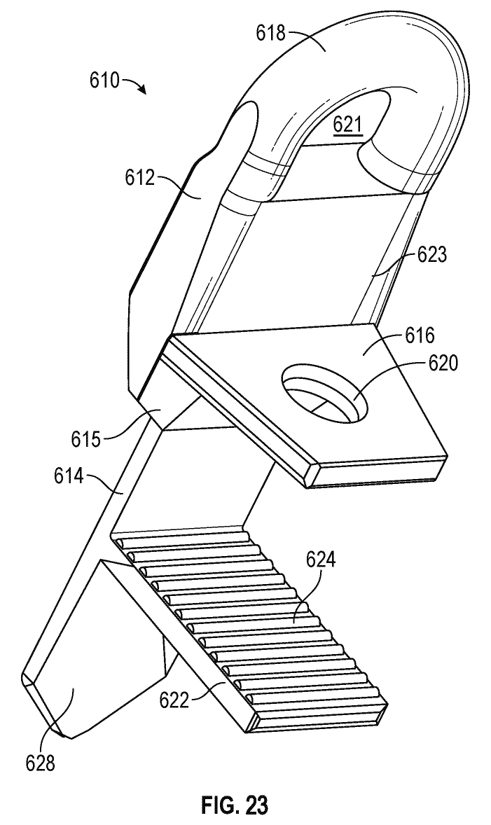

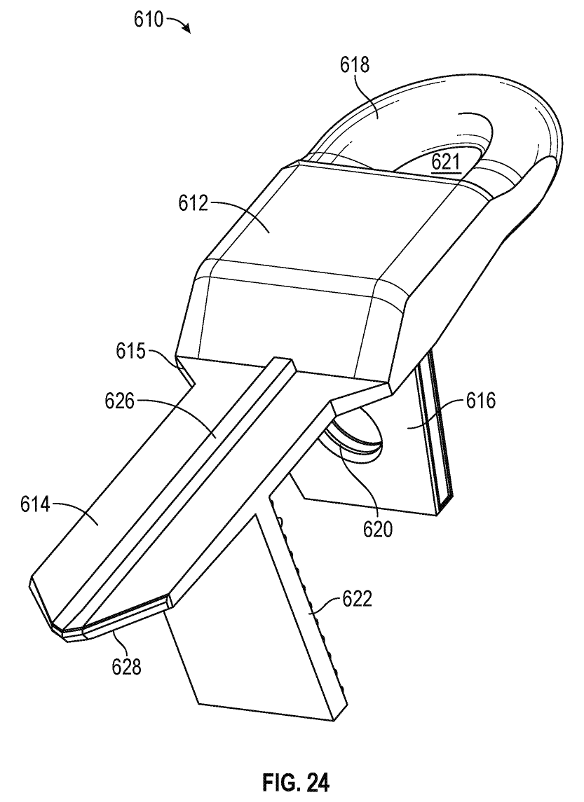

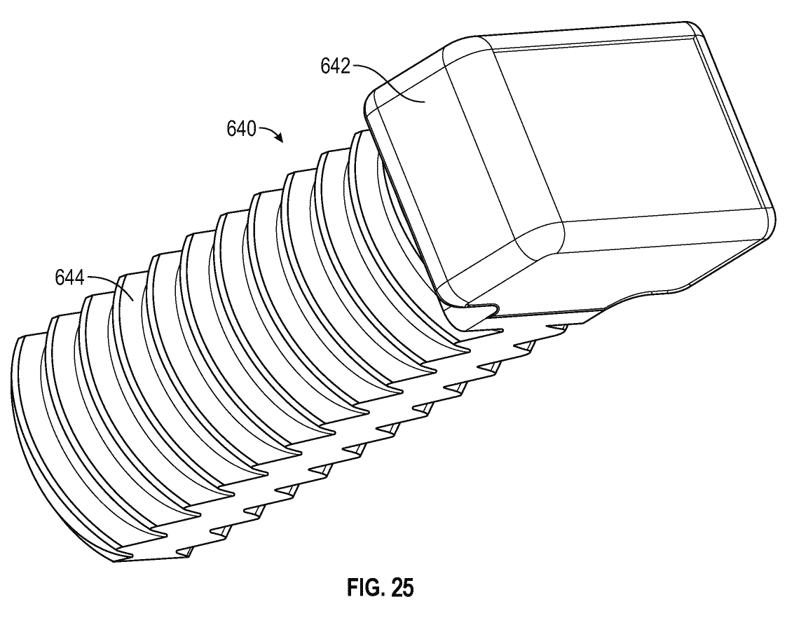

FIGS. 23–24 show the anchorable prop 610. The anchorable prop 610 includes a body 612, a narrow extension 614, a narrowing section 615, a first support 616, a loop 618, a threaded aperture 620, a gap 621 within the loop 618, a second support 622, a bottom 623, a ribbed portion 624, a structural support 626, and a tapering end 628.

The body 612 of the anchorable prop 610 can be generally rectangular in shape and have the narrow extension 614 extending therefrom. The narrow extension 614 also be generally rectangular in shape, and can be either a same thickness as the body 612 or thinner, in which the narrow extension 614 if thinner is configured to do be shaped as such so as to fit easily between the mattress 654 and the bed frame 652 of the bed 650. Between the body 612 and the narrow extension 614 can be the narrowing section 615 which acts as a transitioning portion between the body 612 and the narrow extension 614. As such, the narrowing section 615 can include or be generally triangular or rhombus-shaped which does not preclude the narrowing section 615 from being curved to transition between a thickness of the body 612 and the narrow extension 614.

The body 612 can further include the first support 616 extending from another side of the anchorable prop 610 generally perpendicular to the narrow extension 614, and the loop 618 extending from a side opposite the narrow extension 614. As shown in the figures, the narrow extension 614 and the loop 618 can be generally colinear with the body 612 therebetween, or in a similar plane, each on opposite sides of the body 612. With this configuration, the first support 616 can extend from the body 612 in a generally perpendicular direction with respect to the similar plane formed by the loop 618 and the narrow extension 614. However, the first support 616 need not extend exactly perpendicular to or orthogonal from the body 612 with respect to a plane formed between a direction that the loop 618 extends and a direction that the narrow extension 614 extends. The first support 616 can thus extend from the body 612 in such a way that it is angled closer to either of the loop 618 or the narrow extension 614. The first support 616 further includes the threaded aperture 620 which will be discussed herein.

Extending in a same direction as the first support 616 is the second support 622 which extends from the narrow section 614. In this regard, the first support 616 and the second support 622 extend in a same direction, substantially parallel to one another, with at least some space in between one another as the first support 616 extends from the body 612 and the second support 622 extends from the narrow extension 614, wherein the narrowing section 615 exists therebetween. This allows for the first and second supports 616, 622 to be placed on either side of the bed frame 652 with any and/or all of the body 612, narrowing section 615, and the narrow extension 614 resting on top of the bed frame 652. This configuration allows the anchorable prop 610 to fit on the bed frame 652 and can be secured in place on the bed frame 652 by placement of the mattress 654 on top of the narrow extension 614. As shown in the figures, the narrow extension 614 extends even further than a position at which the second support 622 extends from the narrow extension 614 so as to not only increase balance of the anchorable prop 610 on the bed frame 652 (with the loop 618 extending away from the bed 650), but also to provide additional material to be compressed down on by the mattress 654 thus offering greater stability for the anchorable prop 610 when in use. The narrow extension 614 that extends further under the mattress 654 can further include the tapering end 628 which can be any shape (triangular, curved, etc.) allowing the narrow extension 614 to taper off underneath the mattress 654 to reduce any possibility of feeling the narrow extension 614 on a top side of the mattress 654. The anchorable prop 610 can further have the structural support 626 shown in FIG. 24 which can extend all the way from the body 612 to the tapering end 628, which can be a portion of the narrow extension 614 with an increased thickness to reduce bending of the narrow extension 614, and improve overall strength of the anchorable prop 610.

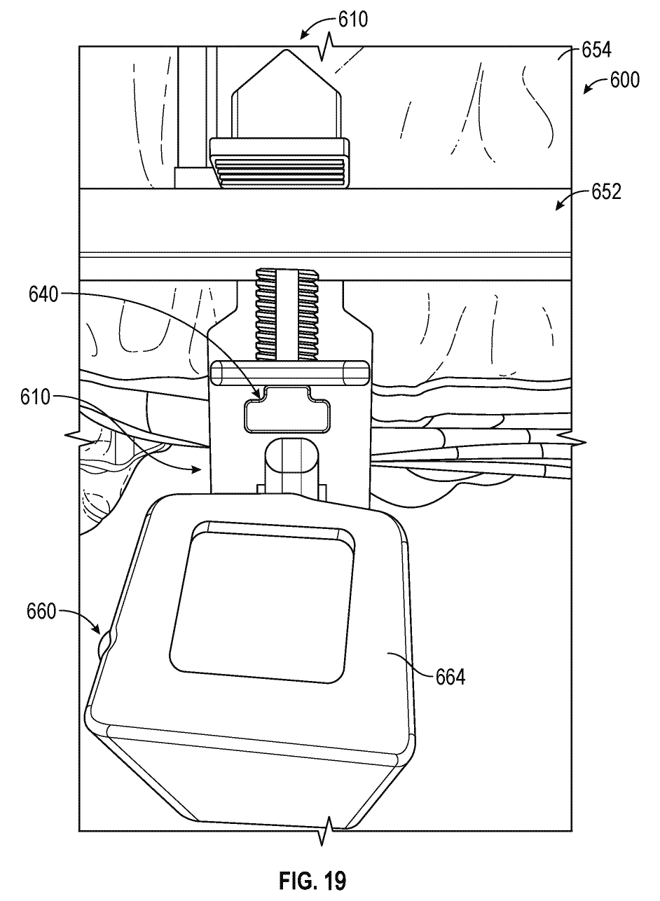

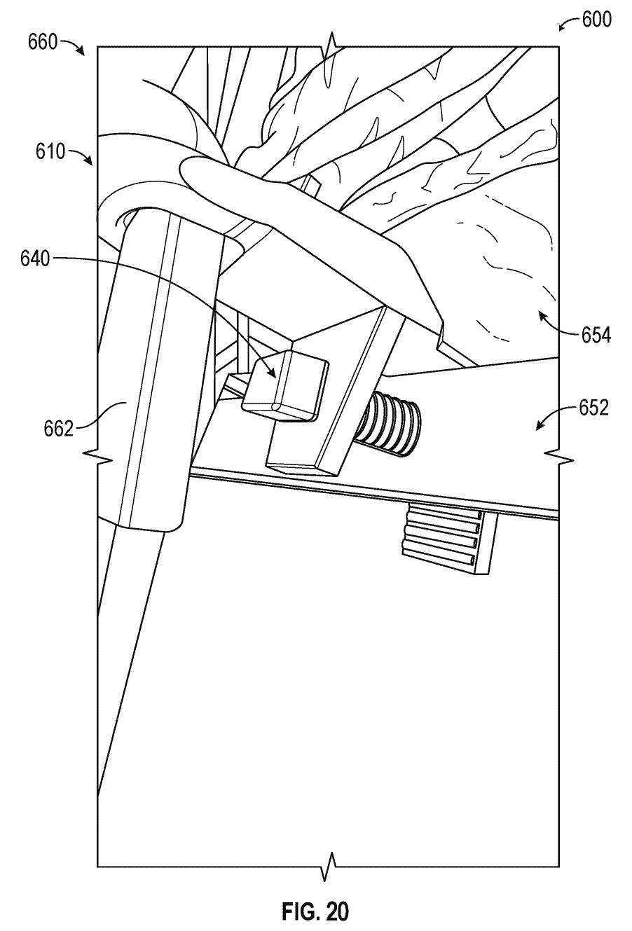

As shown in the figures, the second support 622 includes the ribbed portion 624. The ribbed portion 624 is configured to be placed directly against the bed frame 652 so as to provide roughness, variability, and increased friction against the bed frame 652 for improved stability, reducing slippage, of the anchorable support 610 in interfacing with the bed frame 652. When the ribbed portion 624 is placed against the bed frame 652, the user can then insert the screw 640 into the threaded aperture 620 so as to additionally secure the anchorable prop 610 to the bed 650. As shown in FIGS. 19–20, the screw 640 goes through the threaded aperture 620 and compresses directly against the bed frame 652 to reduce movement of anchorable prop 610 against the bed 650.

FIG. 25 shows a perspective view of the screw 640. The screw 640 can include a head 642 and a threaded portion 644. As shown in the figures, the head 642 can be rectangular in shape so as to allow for ease of installation by human fingers. This allows for the anchorable prop 610 and screw 640 to be 3D printed and thus more gentle on handheld use than heavy and/or small metal parts. Further, flat portions are shown on the threaded portion 644 to assist with 3D printing should the screw 640 be created on its side.

Although not shown in the figures, the anchorable props 110, 210, 310, 410, 510 can further include indents in the top side to allow for customization of the anchorable prop for the user. Given by way of example and not of limitation, the indent can comprise a circular indent in which the circular indent extends between 1mm to 50mm into the top side and can comprise a diameter of 1cm to 7cm in which a circular or cylindrical token can be inserted including a design, identifying mark, or otherwise pleasing to the user designation thereon to which the user can customize. The indent can further comprise a notch at a first end of the circular indent in which a user can insert a fingernail or flathead screwdriver to pop out the circular or cylindrical token so as to place a new token therein. The indent can further comprise a ridge therein so as to assist with securing the token therein. Furthermore, the indent can comprise other shapes to accommodate such tokens that a user would appreciate placing therein such as a square shape, a rectangular shape, a triangular shape, a heart shape, a star shape, a Christmas tree shape, etc. much like decorating a device with stickers.

The anchorable prop can comprise a width of between 1-inch to 6-inches across the body, a length of 4-inches to 16-inches including the loop and the body, and a height of 1-inch to 4-inches from the bottom to the top side. However, the anchorable prop could include any suitable dimensions.

Using the anchorable prop in connection with the wheelchair gives the user who has to use a catheter bag the freedom of being able to have decency, and control of being able to manage their catheter bag themselves especially in comparison to designs that trap the catheter catch bag in a very difficult to access location.

To manufacture the anchorable prop, 3D printing can be used. Through 3D printing one is able to vary the density so it has many layers as it prints giving the anchorable prop a better grip on the seat of the wheelchair which can often be a thin layer of a leather like material, in most cases synthetic. 3D printing allows for getting around hurdles of traditional injection molding. To achieve the desired rigidity in traditional manufacture would require thousands of dollars to create molds that give the built in reinforcement that can be achieved with varying densities in a 3D print. It should be noted that any anchorable prop described herein could be applied and/or included in any system described herein. It should also be noted that any anchorable prop could include any elements and/or characteristics of any other anchorable prop described herein. Furthermore, while specific densities are described below in the Example section, the anchorable props described herein can have any density suitable for maintaining grip to the wheelchair, walker, bed, etc. while simultaneously holding the catheter catch bag or urinal in the air without breaking.

Furthermore, various materials can be used to make the anchorable prop including but not limited to polyethylene terephthalate glycol (“PETG”), thermoplastic polyester elastomer glycol (“TPEG”), polylactic acid (“PLA”), acrylonitrile butadiene styrene (“ABS”), nylon, acrylonitrile styrene acrylate (“ASA”), polyethylene terephthalate glycol carbon fiber (“PETG carbon fiber”), and polylactic acid carbon fiber (“PLA carbon fiber”). In this regard, PETG is a more suitable material as it is less hydrophilic than PLA to keep the possibility of it retaining things like bacteria.

### EXAMPLE

A test was done using a thick metal scraper wedged into the cavity of the anchorable prop with a luggage scale used to test. Pressure was applied till it reached a max number.

With a bottom-up 3D printing by printing on the first side of the anchorable prop: 15% infill with 6 walls, then a band of 70% infill up to the top of the inside of the loop which included the 15% infill 6 walls until the bottom of the finger, then the finger was 70% infill 6 walls, then 15% infill 6 walls until the bottom of the loop. The 70% infill 6 walls, then a small sliver of 15% infill and 6 walls. This was a base version for a test of the anchorable prop. Then 4 versions were printed with just 15% infill but varied the walls as it decreases not only the weight but the strength (also having straight up 15% infill does that also). So, five potential failure test models were as follows in addition to the previous stock or base model identified: 6 walls 15% infill; 5 walls 15% infill; 4 walls 15% infill; 3 walls, 15% infill; the results as following.

Stock with varied infill: 28lbs with slight deformation in an opening of the clamp.

6 walls 15% infill: 26 lbs with an 1/8 inch gap created in the cavity of the body.

5 walls 15% infill: 16 lbs with 1 inch gap created in the cavity of the body.

4 walls 15% infill: 16 lbs Catastrophic failure

3 walls 15% infill: 16 lbs Catastrophic failure.

From the foregoing, it can be seen that the present disclosure accomplishes at least all of the stated objectives.

### GLOSSARY

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order (e.g., first, second, third), a position, and/or an orientation are not limiting and are only referenced according to the views presented.

When an element is referred to as being “connected,” “coupled,” “mated,” “attached,” “fixed,” etc. to another element, the element can be directly connected to the other element, or intervening elements can be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, terms such as (i) “communicatively connected” or (ii) “fluidly connected” include (i) all variations of information exchange and routing between two electronic devices, including intermediary devices, networks, etc., connected wirelessly or not and (ii) all variations of fluid exchange and routing between two fluidic bodies, including intermediary fluid paths, flows, etc., connected indirectly or not.

The terms “invention” or “present invention” are not intended to refer to any single embodiment of the particular invention but encompass all possible embodiments as described in the specification and the claims.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. An anchorable prop, comprising:
a body including a top side and a bottom, the body defining a cavity that is open at a first end of the body, the cavity extending through a first side of the body to a second side of the body;
a loop extending from a second end of the body defining a gap between the loop and the second end of the body; and
a finger protruding from the bottom of the body and extending in a direction towards the loop.

2. The anchorable prop of claim 1, further comprising a ridged portion within the cavity.

3. The anchorable prop of claim 2, wherein the ridged portion comprises a substantially sinusoidal shape.

4. The anchorable prop of claim 1, wherein the finger comprises a continuous curve towards the loop.

5. The anchorable prop of claim 1, wherein the finger includes a bend and a straight portion.

6. The anchorable prop of claim 5, wherein the finger includes a widened portion at a distal end of the finger.

7. The anchorable prop of claim 1, further comprising apertures extending through the body from the bottom to the top side.

8. The anchorable prop of claim 7, wherein the apertures each comprise a different diameter on the bottom than a diameter of the apertures on the top side.

9. The anchorable prop of claim 1, further comprising a bulk portion extending from the bottom in which the finger extends from the bulk portion.

10. The anchorable prop of claim 1, further comprising an indent on the top side, wherein the indent is circular in shape, between five millimeters to thirty millimeters in depth, and including a diameter of 30 millimeters to 60 millimeters.

11. The anchorable prop of claim 1, wherein the anchorable prop is 3D printed and comprises at least one of a PETG material, a TPEG material, an ABS material, a PLA material, an ASA material, a Nylon material, or a carbon fiber material.

12. A system for urine drainage, comprising:
the anchorable prop of claim 1; and
a wheelchair;
wherein the anchorable prop attaches to the wheelchair via receiving a seat of the wheelchair into the cavity.

13. The system of claim 12, wherein a ridged portion within the cavity grips the wheelchair seat.

14. The system of claim 12, further comprising apertures on the body of the anchorable prop, wherein screws are inserted through the apertures and into the wheelchair.

15. The system of claim 12, further comprising a catheter catch bag, and a hook extending from a top of the catheter catch bag, wherein the hook is configured to be positioned within the loop of the anchorable prop.

16. The system of claim 15, further comprising tubing extending from the catheter catch bag to connect with a catheter.

17. The system of claim 16, wherein a portion of the tubing is placed on the finger, the hook extends through the loop, and the hook biases the tubing in a direction away towards the body of the anchorable prop.

18. A method for upholding a catheter catch bag on a wheelchair, comprising:
attaching the anchorable prop of claim 1 to a wheelchair;
placing tubing which is connected to a catheter catch bag above the finger and beneath the loop of the anchorable prop; and
inserting a hook which is connected to the catheter catch bag into the loop such that the hook biases the tubing towards the wheelchair.

19. The method of claim 18, wherein the anchorable prop is positioned at a center point of a front of a wheelchair seat.

20. An anchorable prop for fastening to a bed frame, comprising:
a body;
a loop extending away from the body defining a gap;
a narrow extension extending from the body on a side opposite the loop;
a first support extending from a bottom of the body in between the loop and the narrow extension substantially orthogonal from the body;
a second support extending from the narrow extension substantially orthogonal from the narrow extension; and
a ribbed portion on the second support configured to improve grip against a flat-faced object;
wherein the first support and the second support are spaced apart from one another, and the first support includes an aperture extending therethrough, and the body is thicker than the narrow extension.
